(19) United States
(12) Patent Application Publication
(10) Pub. No.: US 2021/0081388 A1
(43) Pub. Date: Mar. 18, 2021

(54) METHODS, APPARATUSES AND COMPUTER PROGRAM PRODUCTS FOR MANAGING METADATA OF STORAGE OBJECT

(71) Applicant: EMC IP Holding Company LLC, Hopkinton, MA (US)

(72) Inventors: Richard Ding, Shanghai (CN); Jiang Cao, Shanghai (CN); Michael Jingyuan Guo, Shanghai (CN)

(21) Appl. No.: 16/829,870

(22) Filed: Mar. 25, 2020

(30) Foreign Application Priority Data
Sep. 12, 2019 (CN) 201910865367.2

(51) Int. Cl. G06F 16/22; G06F 16/18; G06F 16/182; G06F 16/17; G06F 16/16; G06F 12/1009; G06F 12/02

(52) U.S. Cl. CPC G06F 16/2282; G06F 16/2246; G06F 16/1815; G06F 12/0246; G06F 16/1734; G06F 16/164; G06F 12/1009; G06F 16/182

(57) ABSTRACT

Metadata of a storage object is managed. For instance, in response to metadata of a storage object being updated, a first index structure for indexing the metadata of the storage object and a page table corresponding to the first index structure in a memory are updated, wherein the first index structure and the page table have been stored in a persistent storage device. Updates of the page table are recorded in at least one page table journal and the updated first index structure and the at least one page table journal are stored in the persistent storage device. Embodiments can significantly increase the speed of failover and persistence of metadata in a distributed object storage system.

### RELATED APPLICATION

The present application claims the benefit of priority to Chinese Patent Application No. 201910865367.2, filed on Sep. 12, 2019, which application is hereby incorporated into the present application by reference herein in its entirety.

### FIELD

Embodiments of the present disclosure generally relate to the field of data storage, and more specifically, to methods, apparatuses and computer program products for managing metadata of a storage object.

### BACKGROUND

A distributed object storage system typically does not rely on a file system to manage data. In a distributed object storage system, all storage space can be divided into fixed-size chunks. User data can be stored as objects (also referred to as “storage objects”) in a chunk. An object may have associated metadata for recording attributes and other information of the object (such as the address of the object, etc.). Before actually accessing a storage object, it is usually necessary to first access the metadata of the storage object.

Metadata needs to be stored in a persistent storage device (for example, a disk), otherwise it may get lost in a failure scenario such as when a storage service or storage node restarts. If a storage node in the distributed object storage system fails, metadata managed by the failed node may be failed over to another storage node. Before the other storage node can serve an access request for the metadata, it needs to restore the metadata from the persistent storage device into the memory. The speed of metadata persistence and failover is an important metric to measure system availability. Therefore, it is desirable to provide a scheme for managing metadata of storage objects to increase the speed of metadata failover and persistence.

### SUMMARY

Embodiments of the present disclosure provide methods, apparatuses and computer program products for managing metadata of a storage object.

In a first aspect of the present disclosure, there is provided a method for managing metadata of a storage object. The method comprises: in response to metadata of a storage object being updated, updating a first index structure for indexing the metadata of the storage object and a page table corresponding to the first index structure in a memory, wherein the first index structure records a mapping relationship between a first identifier of the storage object and a second identifier of a page where the metadata of the storage object is located, the page table records a mapping relationship between the second identifier and a page address of the page, and wherein the first index structure and the page table have been stored in a persistent storage device; recording updates of the page table in at least one page table journal; and storing the updated first index structure and the at least one page table journal in the persistent storage device.

In a second aspect of the present disclosure, there is provided a method for managing metadata of a storage object. The method comprises: reading, from a persistent storage device into a memory, a first index structure for indexing metadata of a storage object and at least a part of a page table corresponding to the first index structure, wherein the first index structure records a mapping relationship between a first identifier of the storage object and a second identifier of a page where the metadata of the storage object is located, and the page table records a mapping relationship between the second identifier and a page address of the page; and in response to receiving a first request to access the metadata of the storage object, accessing the metadata of the storage object based on the first index structure and the at least a part of the page table.

In a third aspect of the present disclosure, there is provided an apparatus for managing metadata of a storage object. The apparatus comprises at least one processing unit and at least one memory. The at least one memory is coupled to the at least one processing unit and stores instructions for execution by the at least one processing unit. The instructions, when executed by the at least one processing unit, cause the apparatus to perform actions comprising: in response to metadata of a storage object being updated, updating a first index structure for indexing the metadata of the storage object and a page table corresponding to the first index structure in a memory, wherein the first index structure records a mapping relationship between a first identifier of the storage object and a second identifier of a page where the metadata of the storage object is located, the page table records a mapping relationship between the second identifier and a page address of the page, and wherein the first index structure and the page table have been stored in a persistent storage device; recording updates of the page table in at least one page table journal; and storing the updated first index structure and the at least one page table journal in the persistent storage device.

In a fourth aspect of the present disclosure, there is provided an apparatus for managing metadata of a storage object. The apparatus comprises at least one processing unit and at least one memory. The at least one memory is coupled to the at least one processing unit and stores instructions for execution by the at least one processing unit. The instructions, when executed by the at least one processing unit, cause the apparatus to perform actions comprising: reading, from a persistent storage device into a memory, a first index structure for indexing metadata of a storage object and at least a part of a page table corresponding to the first index structure, wherein the first index structure records a mapping relationship between a first identifier of the storage object and a second identifier of a page where the metadata of the storage object is located, and the page table records a mapping relationship between the second identifier and a page address of the page; and in response to receiving a first request to access the metadata of the storage object, accessing the metadata of the storage object based on the first index structure and the at least a part of the page table.

In a fifth aspect of the present disclosure, there is provided a computer program product tangibly stored on a non-transitory computer readable medium and comprising machine executable instructions that, when executed by a device, cause the device to perform the method according to the first aspect of the present disclosure.

In a sixth aspect of the present disclosure, there is provided a computer program product tangibly stored on a non-transitory computer readable medium and comprising machine executable instructions that, when executed by a device, cause the device to perform the method according to the second aspect of the present disclosure.

This Summary is provided to introduce a selection of concepts in a simplified form that are further described below in the Detailed Description. This Summary is not intended to identify key features or essential features of the present disclosure, nor is it intended to be used to limit the scope of the present disclosure.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a schematic diagram of an example environment in which embodiments of the present disclosure herein can be implemented;

FIG. 2 illustrates a schematic diagram for indexing metadata of storage objects using a B+ tree in a traditional scheme;

FIG. 3 illustrates a schematic diagram for indexing metadata of storage objects using a B+ tree and a page table in a traditional scheme;

FIG. 4 illustrates a schematic diagram for persisting a page table in a traditional scheme;

FIG. 5 illustrates a flowchart of an example method for managing metadata of a storage object in accordance with embodiments of the present disclosure;

FIG. 6 illustrates a schematic diagram for persisting metadata of storage objects and its index structure in accordance with embodiments of the present disclosure;

FIG. 7 illustrates a schematic diagram for persisting a page table by storing page table journals into a persistent storage device in accordance with embodiments of the present disclosure;

FIG. 8 illustrates a schematic diagram for storing a page table in a persistent storage device with both a data part and an index part in accordance with embodiments of the present disclosure;

FIG. 9 illustrates a schematic diagram for merging page table journals in accordance with embodiments of the present disclosure;

FIG. 10 illustrates a schematic diagram for restoring metadata of a storage object in accordance with embodiments of the present disclosure;

FIG. 11 illustrates a schematic diagram for restoring a page table in a memory in accordance with embodiments of the present disclosure;

FIG. 12 illustrates a schematic diagram for restoring a page table in a memory in accordance with embodiments of the present disclosure;

FIG. 13 illustrates a flowchart of an example method for managing metadata of a storage object in accordance with embodiments of the present disclosure;

FIG. 14 illustrates a schematic block diagram of an example device for implementing embodiments of the present disclosure.

In the various figures, the same or corresponding reference numerals indicate the same or corresponding parts.

### DETAILED DESCRIPTION OF EMBODIMENTS

Preferred embodiments of the present disclosure will be described in more details below with reference to the drawings. Although the drawings illustrate preferred embodiments of the present disclosure, it should be appreciated that the present disclosure can be implemented in various manners and should not be limited to the embodiments explained herein. On the contrary, the embodiments are provided to make the present disclosure more thorough and complete and to fully convey the scope of the present disclosure to those skilled in the art.

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The terms “one example embodiment” and “one embodiment” are to be read as “at least one example embodiment.” The term “a further embodiment” is to be read as “at least a further embodiment.” The terms “first”, “second” and so on can refer to same or different objects. The following text also can include other explicit and implicit definitions.

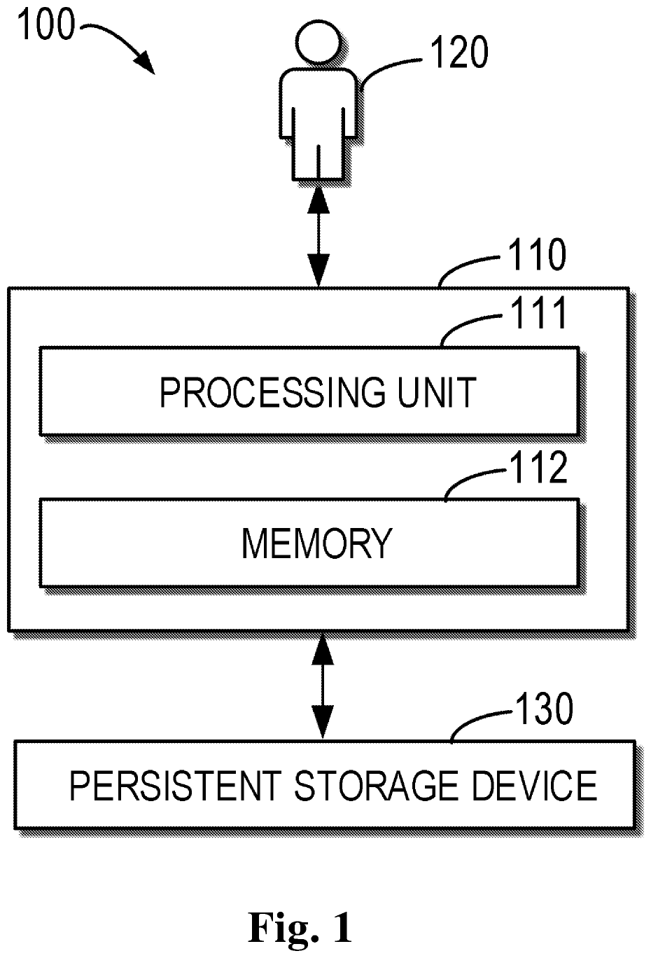

FIG. 1 illustrates a schematic diagram of an example environment 100 in which embodiments of the present disclosure herein can be implemented. It is to be understood that the structure of the environment 100 in FIG. 1 is illustrated only for the purpose of illustration, without suggesting any limitation to the scope of the present disclosure. For example, embodiments of the present disclosure can be applied to an environment different from the environment 100.

As shown in FIG. 1, the environment 100 may include a host 110 and a persistent storage device 130 accessible by the host 110. The host 110 may include a processing unit 111 and a memory 112. The host 110 can be any physical computer, server, or the like. Examples of the memory 112 may include, but are not limited to, a random access memory (RAM), a read only memory (ROM), an erasable programmable read only memory (EPROM or flash), a static random access memory (SRAM), and the like. The persistent storage device 130 may be a storage device separate from the host 110, which may be shared by a plurality of hosts (only one of which is shown in FIG. 1). The persistent storage device 130 can be implemented using any non-volatile storage medium currently known or to be developed in the future, such as a magnetic disk, an optical disk, a disk array, and the like. For example, the persistent storage device 130 may include one or more magnetic disks, optical disks, disk arrays, and the like.

The environment 100 can be implemented as a distributed object storage system. In the following, the environment 100 is sometimes referred to as the distributed object storage system 100. For example, the storage space of the persistent storage device 130 may be divided into fixed size chunks. User data may be stored as storage objects in the chunks. A storage object may have associated metadata for recording attributes and other information (such as, the address of the object, etc.) of the object. The metadata of the storage object may be stored in at least some of the chunks in units of pages. A user 120 may access a storage object in the distributed object storage system 130. For example, the user 120 may send a request to the host 110 to access a certain storage object. In response to receiving the request, the host 110 may first access the metadata of the storage object, for example to obtain the address, attributes, and other information of the object. Then, the host 110 may access user data corresponding to the storage object based on the metadata of the storage object, and return the user data to the user 120.

Metadata needs to be stored on a persistent storage device due to its importance, otherwise it may get lost in a failure scenario such as when a storage service or storage node restarts. For example, the chunks on the persistent storage device 130 can be partitioned into different partitions to store user data (e.g., storage objects) and metadata of the storage objects respectively. If a storage node (e.g., a host) in the distributed object storage system 100 fails, metadata managed by the failed node may be failed over to another storage node (for example, another host not shown in FIG. 1). Before the other storage node can serve an access request for the metadata, it needs to restore the metadata from the persistent storage device into the memory. The speed of metadata persistence and failover is an important metric to measure system availability. Therefore, it is desirable to provide a scheme for managing metadata of storage objects to increase the speed of metadata failover and persistence.

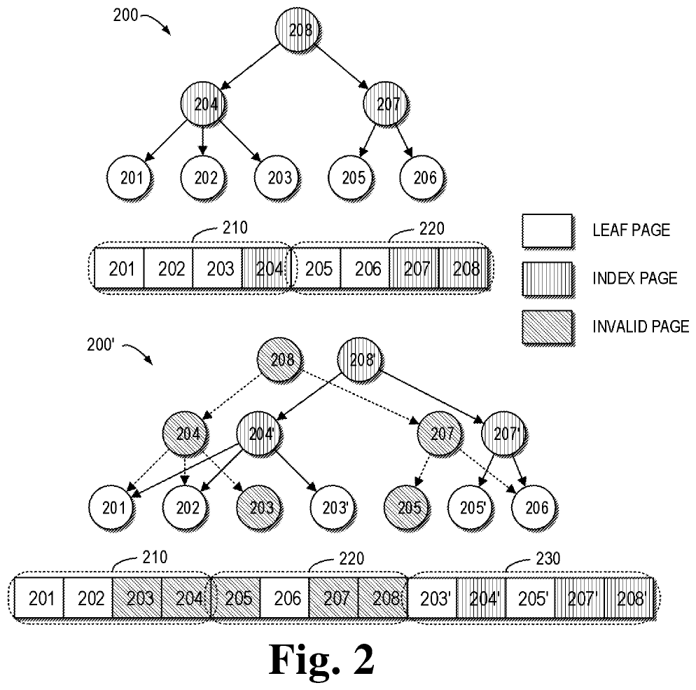

In a chunk-based object storage system, data is written into chunks in an append-only fashion. That is, chunks do not modify/delete the existing content but append updates at the end or in a new chunk when new content arrives. For the chunk-based object storage system, a B+ Tree is frequently used to index metadata of storage objects. For example, a leaf node of the B+ tree (since the node is stored as a page, hence referred to as a “leaf page”) is used to store a key-value pair consisting of an identifier (ID) and metadata of the object. A non-leaf node (also referred to as an “index node” or “index page”) is used to record index information of leaf pages (e.g., addresses of the leaf pages). When the metadata of the storage object gets updated, a corresponding leaf page will be written to a different location in chunks. As the locations of the leaf pages are updated, a corresponding index page needs to be re-rewritten to another different location as well. This will introduce write amplification in the system (i.e., a small number of updates result in a large number of write operations). FIG. 2 illustrates such an example.

FIG. 2 illustrates a B+ tree 200 for indexing metadata of storage objects in a traditional scheme. In FIG. 2, leaf pages 201, 202, 203, 205, and 206 respectively store key-value pairs consisting of identifiers and metadata of storage objects. Index pages 204, 207, and 208 respectively store index information for the leaf pages 201, 202, 203, 205, and 206. For example, the nodes 201, 202, 203, and 204 are stored in a chunk 210, and the nodes 205, 206, 207, and 208 are stored in a chunk 220.

In some cases, for example, the metadata stored by the nodes 203 and 205 may be updated. Therefore, as shown by the updated B+ tree 200′, the leaf page 203 may be updated to a leaf page 203′ and the leaf page 205 may be updated to a leaf page 205′. Since the leaf page 203 is updated to the leaf page 203′, the index page 204 may be updated to an index page 204′. Since the leaf page 205 is updated to the leaf page 205′, the index page 207 may be updated to an index page 207′ accordingly. Thus, the root node 208 may be updated to a root node 208′. Since the data is written into the chunks in an append-only manner, the nodes 203 and 204 in the chunk 210 and the nodes 205, 207 and 208 in the chunk 220 may be invalidated, while the updated nodes 203′, 204′, 205′, 207′ and 208′ may be written to a new chunk 230.

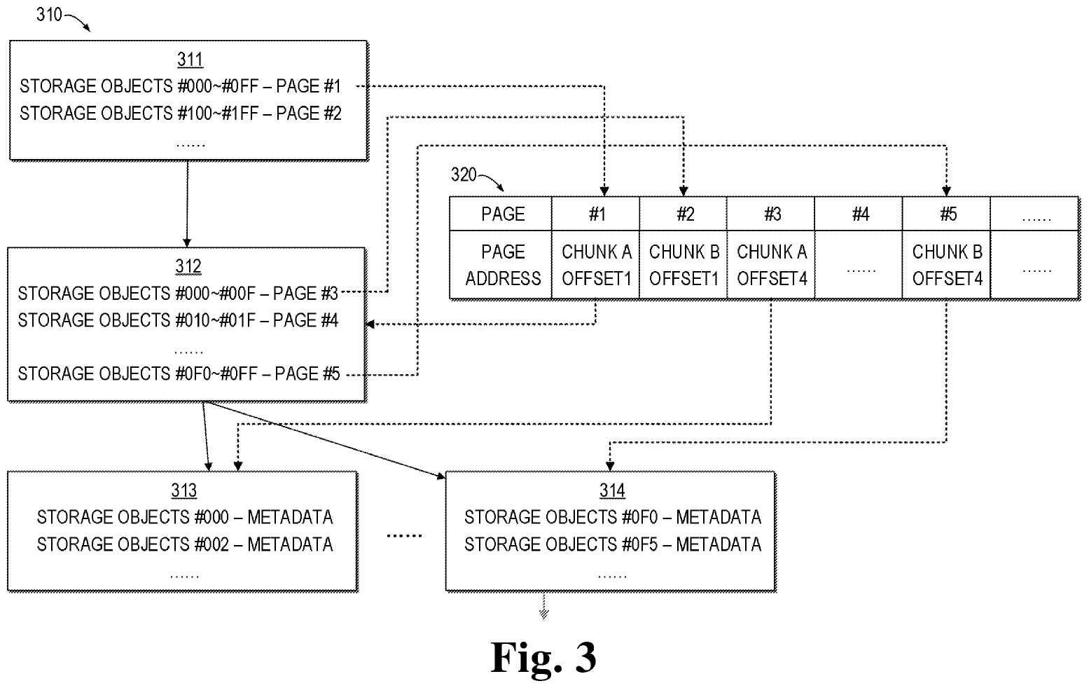

To solve the write amplification issue shown in FIG. 2, some traditional schemes adopt both an innovative B+ Tree structure and a page table to index metadata of storage objects. Different from the traditional scheme as shown in FIG. 2, in these schemes, leaf nodes in the B+ tree are still used to record metadata of storage objects and index nodes are used to record a mapping relationship between IDs of the storage objects and the metadata of the storage objects (for example, in the form of key-value pairs). These schemes may use the page table corresponding to the B+ tree to record a mapping relationship between page IDs and page addresses. In this way, when the leaf pages in the B+ tree are updated, only the page addresses in the page table need to be updated. Data in the index pages can remain unchanged, therefore mitigating the write amplification issue. FIG. 3 illustrates such an example.

FIG. 3 illustrates a B+ tree 310 and a page table 320 corresponding thereto for indexing metadata of storage objects. As shown in FIG. 3, leaf nodes 313, 314 . . . of the B+ tree may respectively record metadata of one or more storage objects, while an index node 312 and a root node 310 may record the mapping relationship between storage object IDs and page IDs. Respective addresses of the pages are recorded in the page table 320. For example, when metadata of a storage object #000 is to be accessed, a page #1 associated with the storage object #000 can be found by searching the root node 310. The address of the page #1 can be determined by searching the page table 320, thereby the index node 312 can be found from the address. The page #3 associated with the storage object #000 can be found by searching the index node 312. The address of the page #3 can be determined by searching the page table 320, thereby the leaf node 313 can be found from the address. Further, the metadata of the storage object #000 can be found in the leaf page 313.

As shown in FIG. 3, the page table may record the mapping relationship between page IDs and page locations for each B+ Tree. To avoid losing the page table in the event of a failure, when persisting the updated B+ Tree, the corresponding page table needs to be persisted as well.

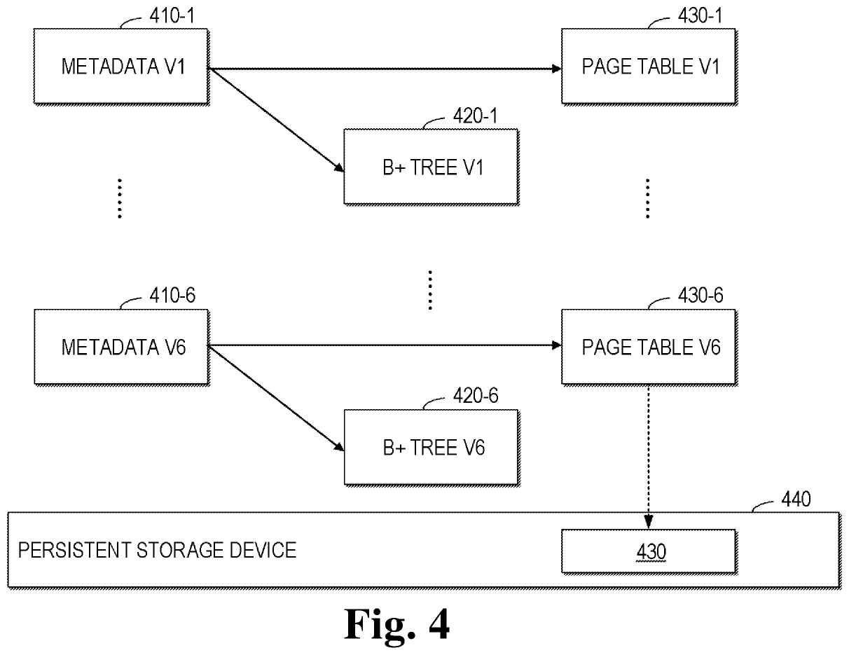

FIG. 4 illustrates a schematic diagram for persisting a page table in a traditional scheme. FIG. 4 shows B+ trees 420-1, 420-2 . . . 420-6 (collectively or individually referred to as “B+ tree(s) 420”) of different versions and their corresponding page tables 430-1, 430-2 . . . 430-6 (collectively or individually referred to as “page table(s) 430”). For example, both the B+ tree 420-1 and the page table 430-1 with a version number of 1 (represented as “V1”) may correspond to metadata 410-1 of Version V1 in the system. If the metadata is updated, the B+ tree and the corresponding page table may be updated accordingly. When the data for each version of the B+ tree 420 is stored in the persistent storage device 440, the corresponding page table 430 may also be stored in the persistent storage device 440. if a failover occurs, the page table 430 may be read from the persistent storage device 440 and restored in the memory before the storage system can serve an access request for the metadata associated with the page table 430.

It is noted that, for a distributed object storage system, as more and more data is injected into the system, metadata will grow accordingly. In the system which uses a B+ tree and a corresponding page table to index metadata, the page table will also grow accordingly. This may cause several issues.

First, the duration for a failover of metadata will increase as the size of the page table increases. During a system failover, the page table needs to be loaded into the memory before the system can serve access requests for metadata. For example, if the traditional page table structure shown in FIG. 3 is used, in order to load a page table for a B+ Tree with 10 million pages (i.e., 10 million nodes), the system needs to load about 75 MB data and restore the data in the memory. It will take, for example, at least 0.5 to 1 seconds. In addition, as the size of the page table increases, the traditional scheme that restores the page table from the persistent storage device will result in more input/output (I/O) operations. If a storage node fails, the system needs to fail over all metadata managed by the failed node to other nodes. This may bring a lot of I/O operations to the system, which may not only result in longer time for failover, but also result in a delay in responding to user read/write requests. This will also make availability and scalability of the system even worse. Meanwhile, in the traditional scheme, it will require more time to persist a page table with the growth of metadata. Since the system needs to continue to provide responses to read/write requests for metadata during metadata persistence, updates to the metadata need to be cached in the memory until the persistence is complete. This will bring extra memory consumption to the whole system.

Embodiments of the present disclosure propose a scheme for managing metadata of a storage object, so as to solve one or more of the above problems and other potential problems. In order to avoid the increase of the page table size leading to a long duration of metadata persistence and restoration, the scheme persists a page table by storing only updates to the page table in a persistent storage device. The updates will be merged in the background into a new page table storage structure that includes both a data part and an index part, thereby reducing the time required for restoring the page table during a failover. Hereinafter, embodiments of the present disclosure will be described in detail with reference to the accompanying drawings.

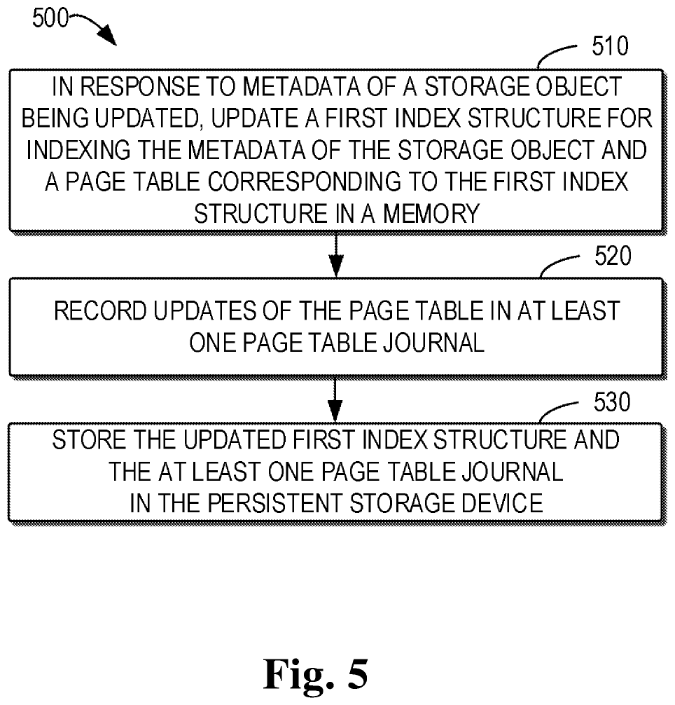

FIG. 5 illustrates a flowchart of an example method 500 for managing metadata of a storage object in accordance with embodiments of the present disclosure. For example, the method 500 can be performed by the host 110 as shown in FIG. 1 for persisting metadata of a storage object and its index structure. It is to be understood that the method 500 may also include additional acts not shown and/or may omit some shown acts, and the scope of the present disclosure is not limited in this respect.

At block 510, in response to metadata of a storage object being updated, the host 110 updates a first index structure for indexing the metadata of the storage object and a page table corresponding to the first index structure in the memory 112. It is assumed here that before the update, the first index structure and the page table corresponding to the first index structure have been stored in the persistent storage device 130. The first index structure may record a mapping relationship between an ID (also referred to as “first identifier” herein) of the storage object and an ID (also referred to as “second identifier” herein) of a page where the metadata of the storage object is located. The page table may record a mapping relationship between the second identifier and a page address of the page.

In some embodiments, the first index structure may be implemented, for example, as the B+ tree structure shown in FIG. 3. Alternatively, in other embodiments, the first index structure may also be implemented with other data structures than the B+ tree. In the following, the B+ tree will be taken as an example of the first index structure. It is to be understood that this is merely for the purpose of illustration, without suggesting any limitation to the scope of the disclosure. If the first index structure is implemented as the B+ tree structure shown in FIG. 3, the page table corresponding to the first index structure in the memory 112 may be, for example, the page table 320 as shown in FIG. 3.

At block 520, the host 110 records updates of the page table in at least one page table journal. Then, at block 530, the host 110 stores the updated first index structure and the at least one page table journal in the persistent storage device 130.

In some embodiments, when persisting metadata, the pages in the B+ Tree may be first stored in the persistent storage device 130 according to the traditional scheme. However, when updating the page table with a page address corresponding to a page ID, adding a new page in the page table or removing a page from the page table, updates of the page table can be recorded in a page table journal, which is also referred to as a PTJ in the following. After storing the updated B+ Tree in the persistent storage device 130, the page table journal, instead of the new version of the page table, can be stored in the persistent storage device 130. Persistence of metadata and its index structure can be performed periodically (e.g., every once in a while) or can be performed in response to a certain persistence command.

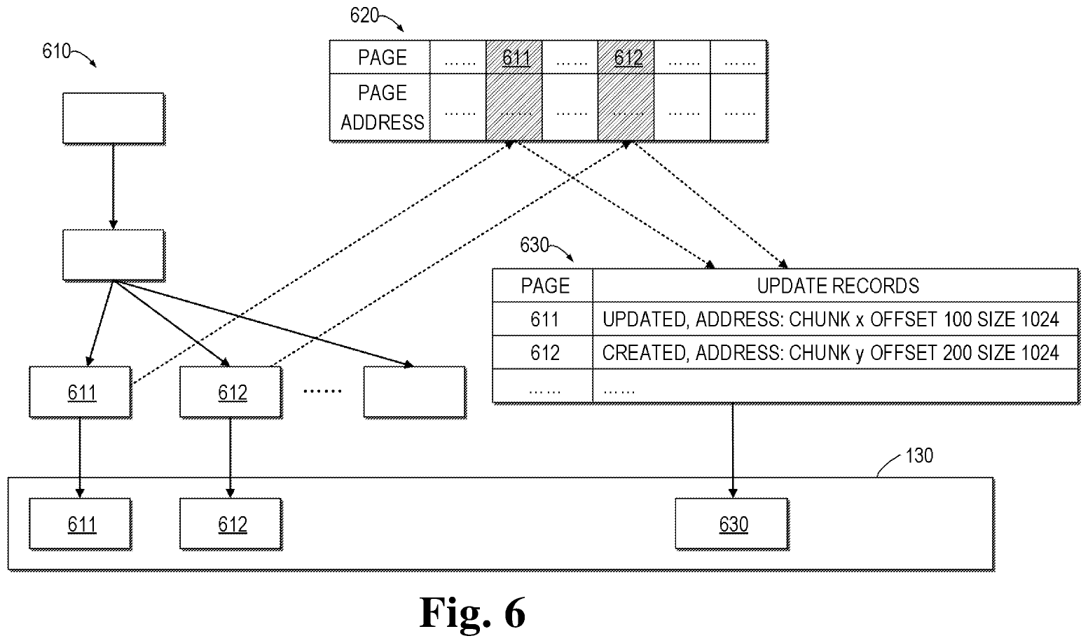

FIG. 6 illustrates a schematic diagram for persisting metadata of storage objects and its index structure in accordance with embodiments of the present disclosure. FIG. 6 shows a first index structure (e.g., B+ tree) 610 for indexing metadata of storage objects and a page table 620 corresponding thereto. It is assumed here that a leaf page 611 in the B+ tree 610 is updated and a new leaf page 612 is created. For the updated pages 611 and 612, corresponding entries in the page table 620 may be updated, and updates of the page table 620 may be recorded in a page table journal 630. When persisting the metadata, the updated B+ tree pages 611 and 612 may be stored in the persistent storage device 130 and the page table journal 630 may be stored in the persistent storage device 130.

As described above, persistence of metadata and its index structure can be performed periodically (e.g., every once in a while) or can be performed in response to a certain persistence command. For example, an empty B+ tree and an empty page table may be stored in the persistent storage device 130 during system initialization. In each subsequent execution of the persistence, the updated B+ tree and page table journals of corresponding versions may be stored in the persistent storage device 130.

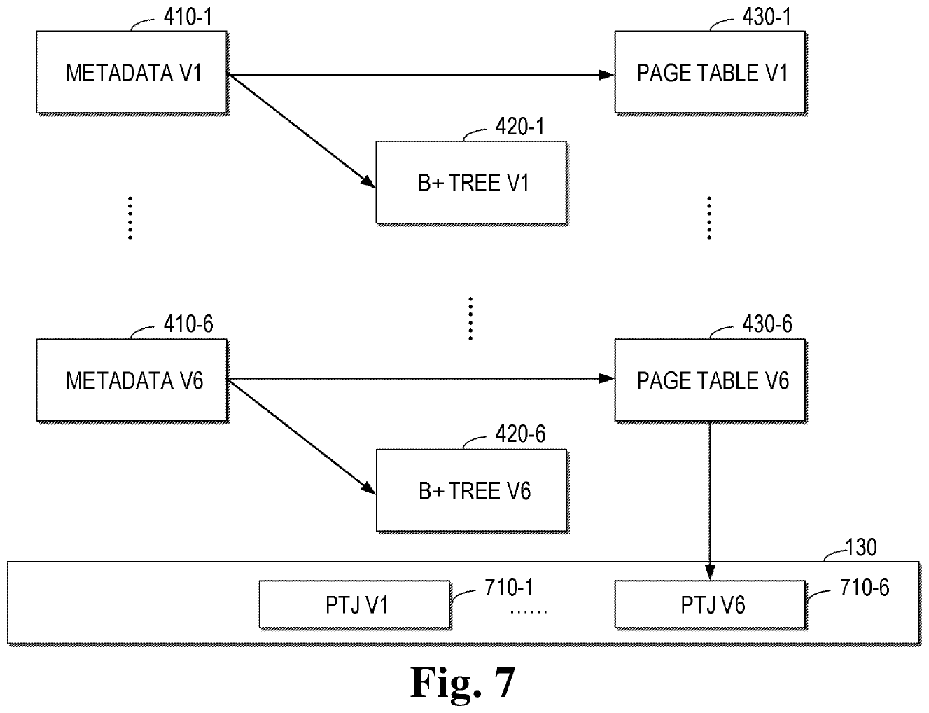

FIG. 7 illustrates a schematic diagram for persisting a page table by storing page table journals into a persistent storage device in accordance with embodiments of the present disclosure. Same as FIG. 4, FIG. 7 shows the B+ trees 420-1, 420-2, . . . 420-6 (collectively or individually referred to as “B+ tree(s) 420”) of different versions and their corresponding page tables 430-1, 430-2 . . . 430-6 (collectively or individually referred to as “page table(s) 430”). For example, both the B+ tree 420-1 and the page table 430-1 with a version number of 1 (presented as “V1”) may correspond to metadata 410-1 of Version V1 in the system. When the metadata is updated, the B+ tree and the corresponding page table will be updated accordingly. Different from FIG. 4, if the data of each version of the B+ tree 420 is stored in the persistent storage device 440, the page table journal for recording updates of the page table of the latest version relative to the page table of the previous version may also be stored in the persistent storage device 440. For example, the page table journal may include a page table journal 710-1 corresponding to the page table 430-1 of Version V1 (for example, it is used to record updates of the page table 430-1 relative to an empty page table), and a page table journal 710-2 corresponding to the page table 430-2 of Version V2 (for example, it is used to record updates of the page table 430-2 relative to the page table 430-1) . . . a page table journal 710-6 corresponding to the page table 430-6 of Version V6.

In some embodiments, each round of metadata persisting may add a new page table journal record to the system with its location on the persistent storage device and a sequence number. Sequence numbers are growing in order, which means that if the system replays all PTJs in order, the latest version of the page table can be derived. However, with more and more rounds of metadata persisting, there will be many PTJ records that need to be read when the system restores the page table into the memory. This will increase the time used to load and replay all PTJs before the system can serve a metadata access request. In addition, this will increase the overhead for metadata storage.

In order to avoid this issue, in some embodiments, the host 110 may initiate a background process to merge page table journals and store the merged result in the persistent storage device 130. In some embodiments, the background process may determine whether at least one page table journal in the persistent storage device 130 is to be merged with the page table of a previous version. In some embodiments, the background process may merge at least one page table journal with the page table of the previous version if a merge condition is satisfied, so as to derive a list of new versions. For example, the merge condition may include at least one of the following: a time since a last merge of page table journals exceeding a threshold time; and an amount of the updates of the page table indicated by the at least one page table journal exceeding a threshold amount. In some embodiments, the background process may store the merged page table of the new version in the persistent storage device 130.

In some embodiments, the merged page table of the new version may be stored in the persistent storage device 130 in both a data part and an index part. For example, the data part may include a plurality of blocks (hereinafter also referred to as “data blocks”) into which the page table of the new version is divided. The data part may be stored in the persistent storage device 130 at first. The index part may be generated based on respective addresses of the plurality of blocks in the persistent storage device and may be stored in the persistent storage device 130 after the data part is stored. As used herein, the index part of the page table is also referred to as the “second index structure.”

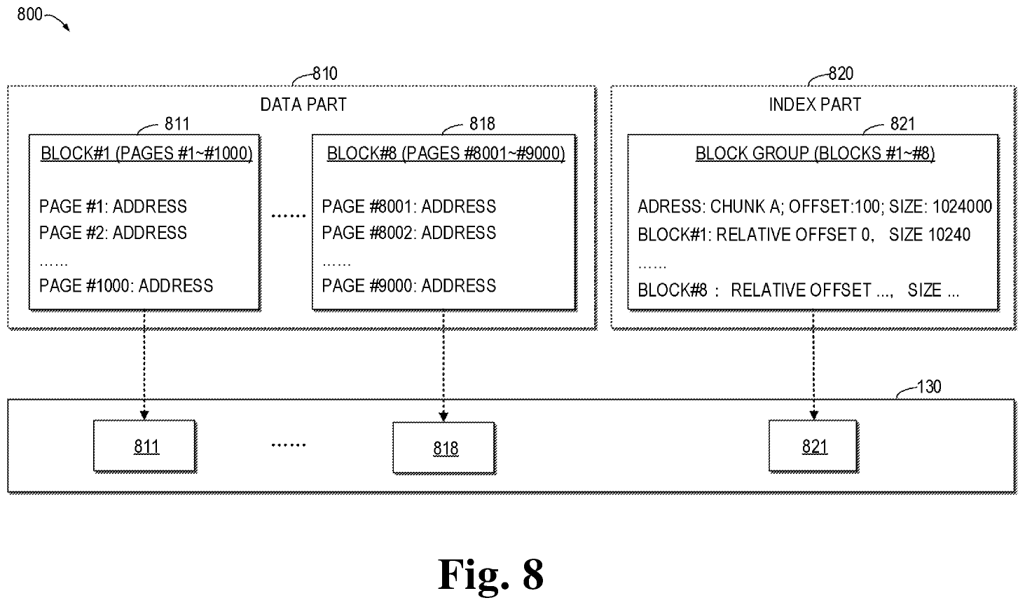

FIG. 8 illustrates a schematic diagram for storing a page table in a persistent storage device with both a data part and an index part in accordance with embodiments of the present disclosure. FIG. 8 shows a page table 800 whose data part 810 may be, for example, divided into a plurality of blocks 811, 812 . . . 818. These blocks may be stored in the persistent storage device 130 in a serial or parallel manner. In some embodiments, these blocks 811, 812 . . . 818 may be further divided into different groups. For example, blocks within the same group may be written serially into a same chunk in persistent storage device 130, while different groups of blocks may be written in parallel into different chunks in persistent storage device 130. An index part 820 of the page table 800 may be generated based on locations of these blocks in the persistent storage device 130, which may include, for example, an index structure 821. In some embodiments, if the blocks 811, 812, . . . 818 are further divided into different groups, the index part 820 may include a plurality of index structures corresponding to different groups, respectively. After the data part 810 is persisted, the index part 820 (e.g., the index structure 821) may be persisted in the persistent storage device 130.

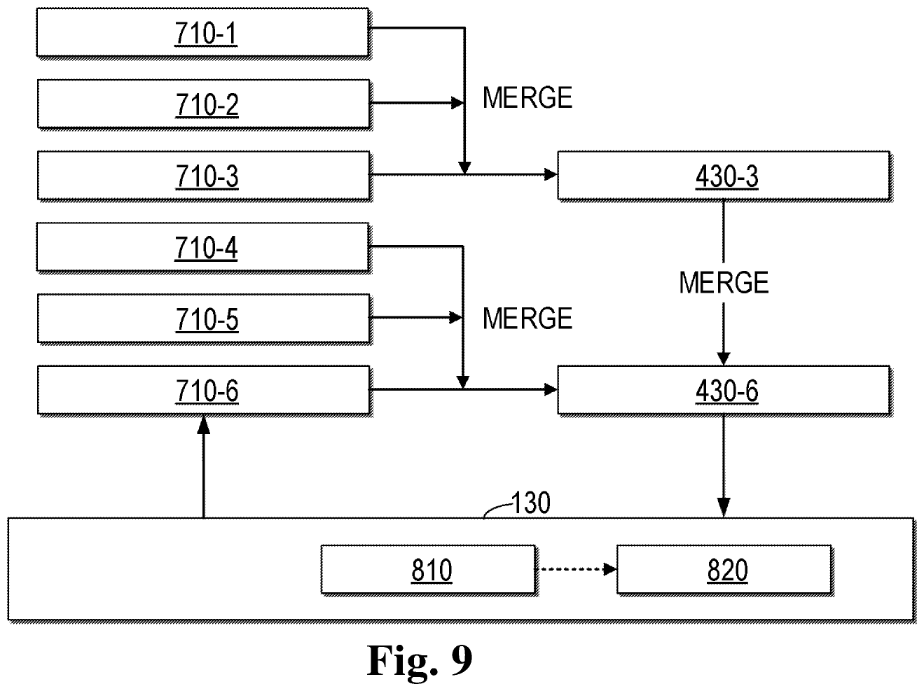

FIG. 9 illustrates a schematic diagram for merging page table journals in accordance with embodiments of the present disclosure. In some embodiments, for example, a background process may periodically check if there are new PTJs that need to be merged. If it is determined that there are new PTJs that need to be merged, the background process may sequentially apply the PTJs to be merged to the data part of the most recently merged page table, generate a new page table index part and store it in the persistent storage device 130. After the PTJs are merged, the storage space occupied by them can be reclaimed and released. As shown in FIG. 9, for example, PTJs 710-1, 710-2 and 710-3 together with a previously merged page table (not shown) may be merged into a page table 430-3. Then, the page table 430-3 may be merged with PTJs 710-4, 710-5, and 710-6 into the page table 430-6. For example, each merged page table 430 may be stored in the persistent storage device 130 as a data part 810 and an index part 820 shown in FIG. 8.

As described above, if a storage node that manages metadata fails, the metadata managed by the failed node may be failed over to another storage node. The other storage node needs to restore the metadata from the persistent storage device into the memory, thereby being able to serve an access request for the metadata.

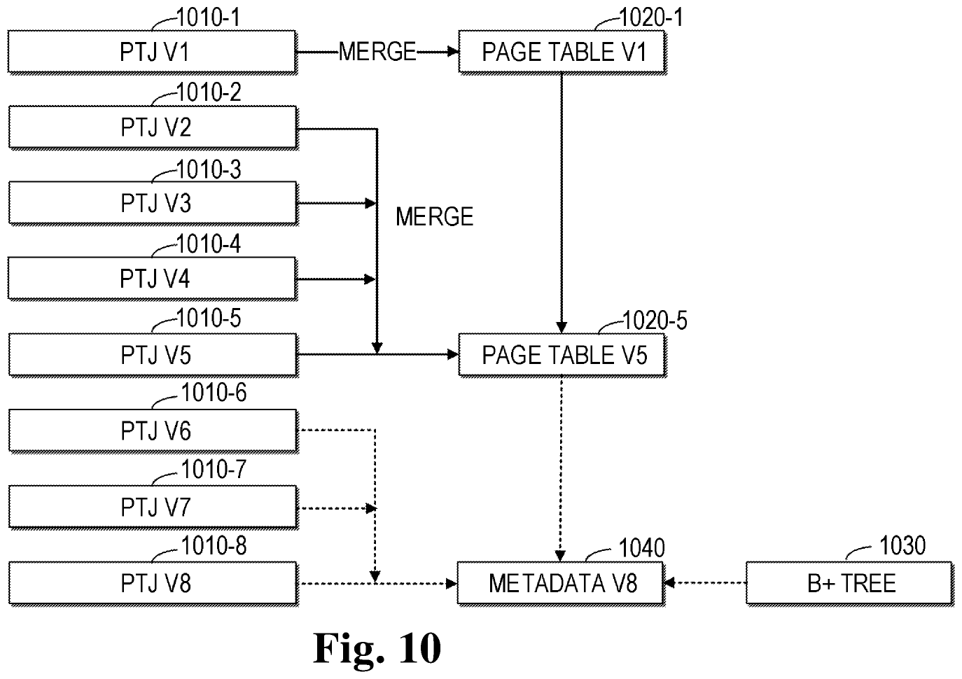

FIG. 10 illustrates a schematic diagram for restoring metadata of a storage object in accordance with embodiments of the present disclosure. As shown in FIG. 10, for example, page table journals 1010-1, 1010-2 . . . 1010-8 of different versions may be stored in the persistent storage device respectively, while a B+ tree 1030 of the latest version may also be stored in the persistent storage device. A background process may merge, for example, the page table journal 1010-1 with the page table of the previous version (not shown) into a page table 1020-1, and further merge the page table 1020-1 with the page table journals 1010-2, 1010-3 . . . 1010-4 into a page table 1020-5. For example, the page table journals 1010-6, 1010-7, and 1010-8 may not be merged. In some embodiments, the most recently merged page table 1020-5, the unmerged page table journals 1010-6, 1010-7, and 1010-8, and the B+ tree 1030 of the latest version may be read from the persistent storage device to restore the latest version of metadata 1040 in the memory.

In some embodiments, in order to shorten the failover duration, the restoration of the page table may be divided into two steps. In the first step, the index part of the most recently merged page table and the remaining unmerged page table journals can be read from the persistent storage device. The structure of the page table to be restored in the memory may be changed correspondingly. For example, the page table in the memory may also be divided into a plurality of blocks. If the index part of the most recently merged page table is read from the persistent storage device into a memory, location information of each block recorded in the index part may be used to initialize each block of the page table in the memory. Then, PTJs may be applied to each block in an order of their versions. In this way, after completing the first step, the memory may have the content of the unmerged PTJs and the location information of each data block of the page table.

At this time, when an access request for metadata is received, at most one additional read operation can be utilized to read corresponding page table content from the persistent storage device. For example, in order to retrieve a location of a page from the page table, the unmerged PTJs may be searched for a record corresponding to the ID of the page. If the record cannot be found, it may be determined, based on the ID of the page, which one of the plurality of data blocks of the page table is associated with the page. Then, the content of the data block can be read from the persistent storage device based on the location information of the data block. In the memory, the content of the data block can be further merged with the content in the PTJs. As such, the system can serve access requests for metadata after completing the first step.

In the second step, data blocks of the page table can be read from the persistent storage device into the memory in parallel in the background. When the data part is loaded into the memory, it can be merged with the content of the unmerged page table journals. After the data part is fully loaded into the memory and merged with the page table journals, the system can serve an access request for metadata without searching the persistent storage device for data blocks of the page table.

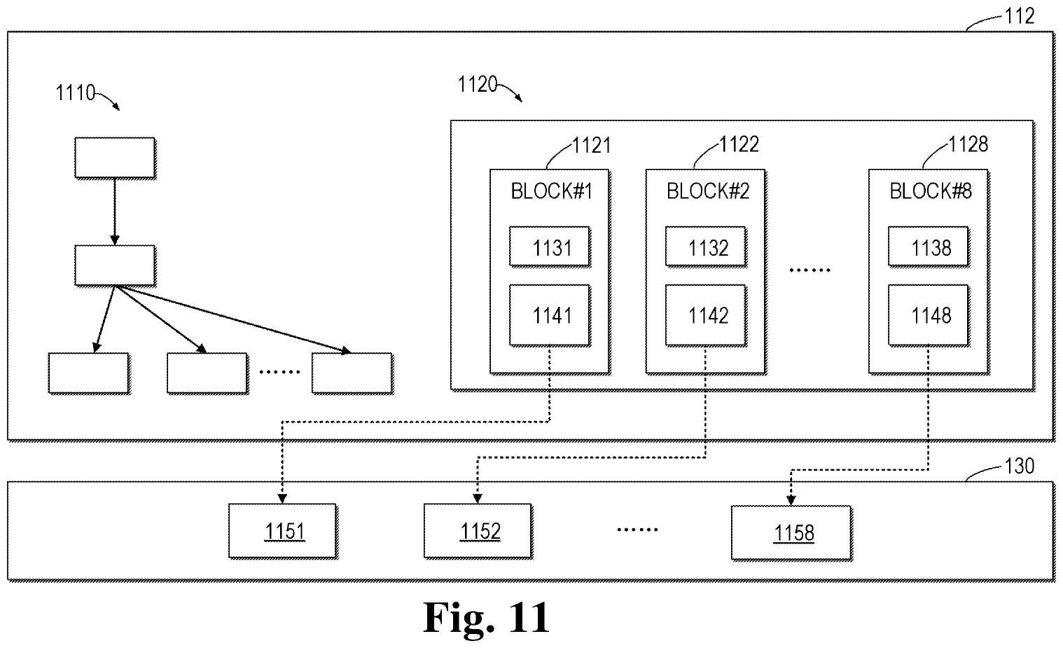

FIG. 11 illustrates a schematic diagram for restoring a page table in a memory in accordance with embodiments of the present disclosure. For example, FIG. 11 illustrates the first step as described above. As shown in FIG. 11, the B+ tree 1110 stored in the persistent storage device 130 may be read into the memory 112. In order to restore the page table 1120 in the memory 112, the index part of the most recently merged page table and the remaining unmerged page table journals may be read from the persistent storage device. The page table 1120 in the memory may be divided into a plurality of blocks 1121, 1122 . . . 1128. If the index part of the most recently merged page table is read from the persistent storage device 130, each block of the page table 1120 in the memory may be initialized with location information of each block recorded in the index part. Then, PTJs may be applied to each block of the page table 1120 in the memory in an order of their versions. In this manner, as shown in FIG. 11, the block 1121 may have an unmerged page table journal 1131 and block location information 1141 associated therewith. For example, the block address information 1141 may indicate a location 1151 where the block 1121 is stored in persistent storage device 130. The block 1122 may have an unmerged page table journal 1132 and block location information 1142 associated therewith. For example, the block location information 1142 may indicate a location 1152 where the block 1122 is stored in the persistent storage device 130. The block 1128 may have an unmerged page table journal 1138 and block location information 1148 associated therewith. For example, the block address information 1148 may indicate a location 1158 where the block 1128 is stored in the persistent storage device 130.

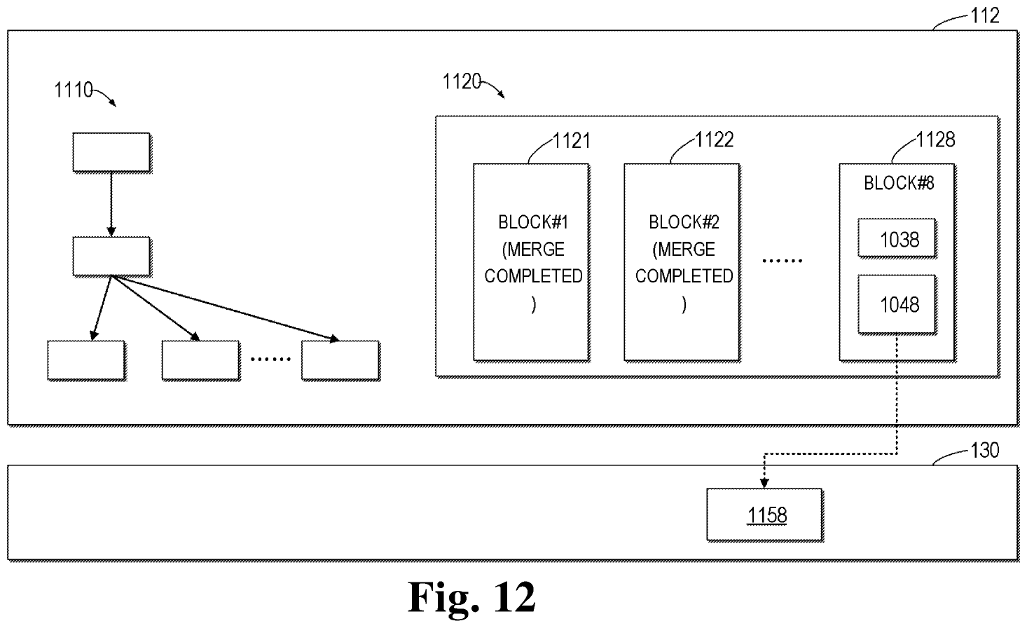

FIG. 12 illustrates a schematic diagram for restoring a page table in a memory in accordance with embodiments of the present disclosure. For example, FIG. 12 illustrates the second step as described above. As shown in FIG. 12, the data blocks 1121, 1122 . . . 1128 of the page table 1120 may be read in parallel from the persistent storage device 130 in the background. For example, when the data part of the data block 1121 is loaded into the memory 112, it may be merged with the content in the unmerged page table journal 1131. After the data part is merged, the content in the data block 1121 of the page table 1120 has been fully restored, so an access request for the metadata associated with the data block 1121 can be served without searching the persistent storage device for the content of the data block 1121. Similarly, similar operations can be performed on the data blocks 1122, 1123 . . . 1128 to restore the entire page table in the memory.

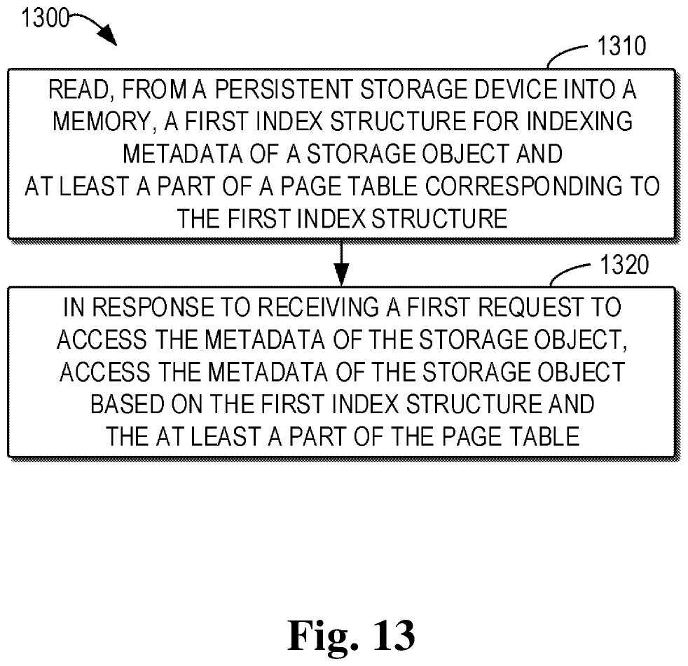

FIG. 13 illustrates a flowchart of an example method 1300 for managing metadata of a storage object in accordance with embodiments of the present disclosure. For example, the method 1300 can be performed by the host 110 as shown in FIG. 1 for restoring metadata of a storage object and responding to an access request for the metadata of the storage object. It is to be understood that the method 1300 can also include additional acts not shown and/or omit some shown acts. The scope of the present disclosure is not limited in this respect.

At block 1310, the host 110 reads, from the persistent storage device 130 into the memory 112, a first index structure for indexing metadata of a storage object and at least a part of a page table corresponding to the first index structure. The first index structure may record a mapping relationship between a first identifier of the storage object and a second identifier of a page where the metadata of the storage object is located, and the page table may record a mapping relationship between the second identifier and a page address of the page.

At block 1320, in response to receiving a first request to access the metadata of the storage object, the host 110 accesses the metadata of the storage object based on the first index structure and the at least a part of the page table.

In some embodiments, the page table stored in the persistent device comprises a plurality of blocks and a second index structure for recording respective addresses of the plurality of blocks in the persistent storage device. Reading the at least a part of the page table comprises reading the second index structure from the persistent storage device.

In some embodiments, accessing the metadata of the storage object comprises extracting the first identifier of the storage object from the first request; determining, by searching the first index structure, the second identifier of the page where the metadata of the storage object is located; determining, from the plurality of blocks, a block associated with the page based on the second identifier; determining an address of the block in the persistent storage device by searching the second index structure; reading the block from the address in the persistent storage device; searching the block for a page address of the page based on the second identifier; and accessing the metadata of the storage object from the page address in the persistent storage device.

In some embodiments, the method 1300 further comprises reading, based on the second index structure, the plurality of blocks from the persistent storage device into the memory to restore the page table in the memory.

In some embodiments, the page table stored in the persistent device comprises a previous page table and at least one page table journal for recording updates of the page table relative to the previous page table, and the previous page table comprises a plurality of blocks and a second index structure for recording respective addresses of the plurality of blocks in the persistent storage device. Reading the at least a part of the page table comprises reading the at least one page table journal and the second index structure from the persistent storage device.

In some embodiments, accessing the metadata of the storage object comprises extracting the first identifier of the storage object from the first request; determining, by searching the first index structure, the second identifier of the page where the metadata of the storage object is located; searching the at least one page table journal for a page address of the page based on the second identifier; and in response to the page address of the page being found in the at least one page table journal, accessing the metadata of the storage object from the page address in the persistent storage device.

In some embodiments, the method 1300 further comprises in response to the page address of the page not being found in the at least one page table journal, determining, from the plurality of blocks, a block associated with the page based on the second identifier; determining an address of the block in the persistent storage device by searching the second index structure; reading the block from the address in the persistent storage device; searching the block for a page address of the page based on the second identifier; and accessing the metadata of the storage object from the page address in the persistent storage device.

In some embodiments, the method 1300 further comprises reading, based on the second index structure, the plurality of blocks from the persistent storage device into the memory to restore the previous page table in the memory; and restoring the page table in the memory by merging the previous page table and the at least one page table journal.

In some embodiments, the first index structure further indexes metadata of a further storage object. The method 1300 further comprises in response to receiving a second request to access the metadata of the further storage object, accessing the metadata of the further storage object based on the first index structure and the page table.

In some embodiments, the first index structure is implemented as a B+ tree.

From the above description, it can be seen that embodiments of the present disclosure can significantly increase the speed of metadata failover and persistence. Since only the index part of the page table and several unmerged page table journals need to be loaded during metadata restoration, a number of disk I/O operations can be saved during metadata failover. In addition, the growth of metadata will extend the period of time during which the metadata is unavailable due to failover, which greatly improves availability and scalability of the system. In addition, according to embodiments of the present disclosure, the I/O burst issue during the page table restoration can be mitigated. Further, the background loading speed of the page table can be throttled to reach a balance between I/O pressure and metadata access performance. This can significantly improve the performance of metadata failover. Meanwhile, during the persistence phase, since only an incremental part between two versions of the page table needs to be persisted, the metadata persistence speed can be greatly improved and the time required for the persistence will no longer grow with the size of the page table. Also, the growth of metadata will no longer impact the time for metadata failover. This means that the memory used for caching metadata updates can be saved during the persistence phase, which will reduce the memory consumption of the system.

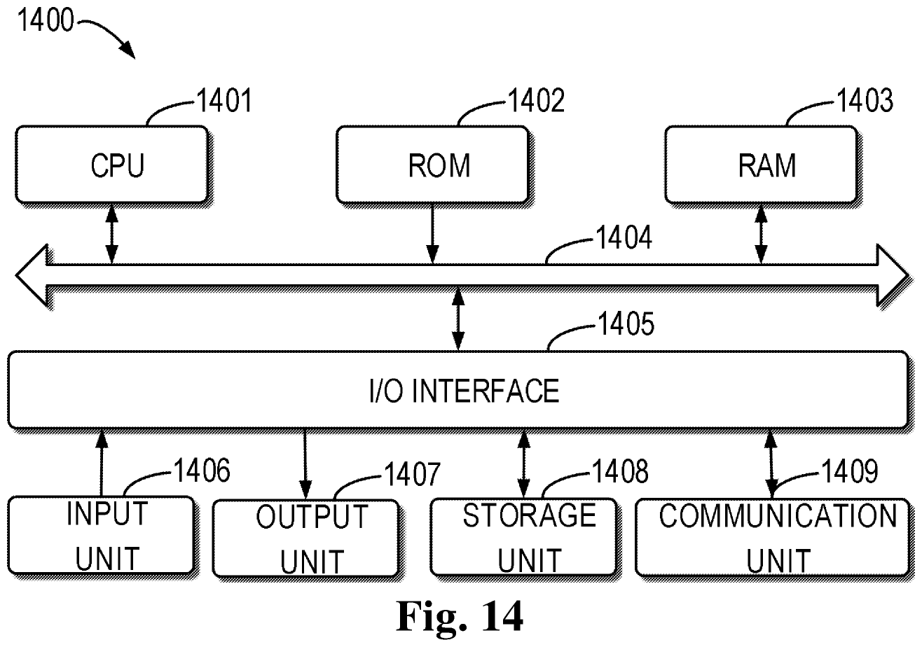

FIG. 14 illustrates a schematic block diagram of an example device 1400 for implementing embodiments of the present disclosure. For example, the host 110 shown in FIG. 1 can be implemented by the device 1400. As shown, the device 1400 includes a central process unit (CPU) 1401, which can execute various suitable actions and processing based on the computer program instructions stored in the read-only memory (ROM) 1402 or computer program instructions loaded in the random-access memory (RAM) 1403 from a storage unit 1408. The RAM 1403 can also store all kinds of programs and data required by the operations of the device 1400. CPU 1401, ROM 1402 and RAM 1403 are connected to each other via a bus 1404. The input/output (I/O) interface 1405 is also connected to the bus 1404.

A plurality of components in the device 1400 is connected to the I/O interface 1405, including: an input unit 1406, such as keyboard, mouse and the like; an output unit 1407, e.g., various kinds of display and loudspeakers etc.; a storage unit 1408, such as magnetic disk and optical disk etc.; and a communication unit 1409, such as network card, modem, wireless transceiver and the like. The communication unit 1409 allows the device 1400 to exchange information/data with other devices via the computer network, such as Internet, and/or various telecommunication networks.

The above described each procedure and processing, such as the method 500 and/or 1300, can also be executed by the processing unit 1401. For example, in some embodiments, the method 500 and/or 1300 can be implemented as a computer software program tangibly included in the machine-readable medium, e.g., storage unit 1408. In some embodiments, the computer program can be partially or fully loaded and/or mounted to the device 1400 via ROM 1402 and/or communication unit 1409. When the computer program is loaded to RAM 1403 and executed by the CPU 1401, one or more steps of the above described method 500 and/or 1300 can be implemented.

The present disclosure can be method, apparatus, system and/or computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but not limited to, such as electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can include copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages consist of object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider). In some embodiments, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Various aspects of the present disclosure are described here with reference to flow chart and/or block diagram of method, apparatus (system) and computer program products according to embodiments of the present disclosure. It should be understood that each block of the flow chart and/or block diagram and the combination of various blocks in the flow chart and/or block diagram can be implemented by computer-readable program instructions.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions contains an article of manufacture, including instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow chart and block diagram in the drawings illustrate system architecture, functions and operations that may be implemented by system, method and computer program product according to multiple implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various implementations of the present disclosure have been described above and the above description is only exemplary rather than exhaustive and is not limited to the implementations of the present disclosure. Many modifications and alterations, without deviating from the scope and spirit of the explained various implementations, are obvious for those skilled in the art. The selection of terms in the text aims to best explain principles and actual applications of each implementation and technical improvements made in the market by each embodiment, or enable other ordinary skilled in the art to understand implementations of the present disclosure.

I/We claim:

1. A method for managing metadata of a storage object, comprising:
in response to the metadata of the storage object being updated, updating, by a system comprising a processor, a first index structure for indexing the metadata of the storage object and a page table corresponding to the first index structure in a memory, resulting in an updated first index structure, wherein the first index structure records a mapping relationship between a first identifier of the storage object and a second identifier of a page where the metadata of the storage object is located, wherein the page table records a mapping relationship between the second identifier and a page address of the page, and wherein the first index structure and the page table have been stored in a persistent storage device;
recording updates of the page table in at least one page table journal; and
storing the updated first index structure and the at least one page table journal in the persistent storage device.

2. The method of claim 1, further comprising:
determining whether the at least one page table journal in the persistent storage device is to be merged with the page table;
in response to determining that the at least one page table journal is to be merged with the page table, merging the page table and the at least one page table journal into an updated page table; and
storing the updated page table in the persistent storage device.

3. The method of claim 2, wherein the determining whether the at least one page table journal is to be merged with the page table comprises:
determining whether a merge condition is satisfied; and
in response to the merge condition being satisfied, determining that the at least one page table journal is to be merged with the page table,
wherein the merge condition comprises at least one of:
a time since a last merge of page table journals exceeding a threshold time, or
an amount of the updates of the page table indicated by the at least one page table journal exceeding a threshold amount.

4. The method of claim 2, wherein the storing the updated page table in the persistent storage device comprises:
dividing the updated page table into a plurality of blocks;
storing the plurality of blocks in the persistent storage device respectively;
generating a second index structure for recording respective addresses of the plurality of blocks in the persistent storage device; and
storing the second index structure in the persistent storage device.

5. The method of claim 1, wherein the first index structure is implemented as a B+ tree.

6. A method for managing metadata of a storage object, comprising:
reading, from a persistent storage device into a memory by a system comprising a processor, a first index structure for indexing the metadata of the storage object and at least a part of a page table corresponding to the first index structure, wherein the first index structure records a mapping relationship between a first identifier of the storage object and a second identifier of a page where the metadata of the storage object is located, and the page table records a mapping relationship between the second identifier and a page address of the page; and
in response to receiving a first request to access the metadata of the storage object, accessing the metadata of the storage object based on the first index structure and at least the part of the page table.

7. The method of claim 6, wherein the page table stored in the persistent device comprises a plurality of blocks and a second index structure for recording respective addresses of the plurality of blocks in the persistent storage device, and reading at least the part of the page table comprises:
reading the second index structure from the persistent storage device.

8. The method of claim 7, wherein the accessing the metadata of the storage object comprises:
extracting the first identifier of the storage object from the first request;
determining, by searching the first index structure, the second identifier of the page where the metadata of the storage object is located;
determining, from the plurality of blocks, a block associated with the page based on the second identifier;
determining an address of the block in the persistent storage device by searching the second index structure;
reading the block from the address in the persistent storage device;
searching the block for a page address of the page based on the second identifier; and
accessing the metadata of the storage object from the page address in the persistent storage device.

9. The method of claim 7, further comprising:
reading, based on the second index structure, the plurality of blocks from the persistent storage device into the memory to restore the page table in the memory, wherein the first index structure further indexes further metadata of a further storage object; and
in response to receiving a second request to access the further metadata of the further storage object, accessing the further metadata of the further storage object based on the first index structure and the page table.

10. The method of claim 6, wherein the page table stored in the persistent device comprises a previous page table and at least one page table journal for recording updates of the page table relative to the previous page table, wherein the previous page table comprises a plurality of blocks and a second index structure for recording respective addresses of the plurality of blocks in the persistent storage device, wherein the reading at least the part of the page table comprises reading the at least one page table journal and the second index structure from the persistent storage device, and wherein the accessing the metadata of the storage object comprises:
extracting the first identifier of the storage object from the first request;
determining, by searching the first index structure, the second identifier of the page where the metadata of the storage object is located;
searching the at least one page table journal for a page address of the page based on the second identifier; and
in response to the page address of the page being found in the at least one page table journal, accessing the metadata of the storage object from the page address in the persistent storage device.

11. The method of claim 10, further comprising:
in response to the page address of the page not being found in the at least one page table journal, determining, from the plurality of blocks, a block associated with the page based on the second identifier;
determining an address of the block in the persistent storage device by searching the second index structure;
reading the block from the address in the persistent storage device;
searching the block for a page address of the page based on the second identifier; and
accessing the metadata of the storage object from the page address in the persistent storage device.

12. The method of claim 10, further comprising:
reading, based on the second index structure, the plurality of blocks from the persistent storage device into the memory to restore the previous page table in the memory; and
restoring the page table in the memory by merging the previous page table and the at least one page table journal.

15. The method of claim 6, wherein the first index structure is implemented as a B+ tree.

16. An apparatus for managing metadata of a storage object, comprising:
at least one processing unit;
at least one memory coupled to the at least one processing unit and storing instructions for execution by the at least one processing unit, the instructions, when executed by the at least one processing unit, causing the apparatus to perform actions comprising:
in response to the metadata of the storage object being updated, updating a first index structure for indexing the metadata of the storage object and a page table corresponding to the first index structure in a memory, the updating the first index structure resulting in an updated first index structure, wherein the first index structure records a mapping relationship between a first identifier of the storage object and a second identifier of a page where the metadata of the storage object is located, wherein the page table records a mapping relationship between the second identifier and a page address of the page, and wherein the first index structure and the page table have been stored in a persistent storage device;
recording updates of the page table in at least one page table journal; and
storing the updated first index structure and the at least one page table journal in the persistent storage device.

17. The apparatus of claim 16, wherein the actions further comprise:
determining whether the at least one page table journal in the persistent storage device is to be merged with the page table;
in response to determining that the at least one page table journal is to be merged with the page table, merging the page table and the at least one page table journal into an updated page table; and
storing the updated page table in the persistent storage device.

18. An apparatus for managing metadata of a storage object, comprising:
at least one processing unit;
at least one memory coupled to the at least one processing unit and storing instructions for execution by the at least one processing unit, the instructions, when executed by the at least one processing unit, causing the apparatus to perform actions comprising:
reading, from a persistent storage device into a memory, a first index structure for indexing the metadata of the storage object and at least a part of a page table corresponding to the first index structure, wherein the first index structure records a mapping relationship between a first identifier of the storage object and a second identifier of a page where the metadata of the storage object is located, and wherein the page table records a mapping relationship between the second identifier and a page address of the page; and
in response to receiving a first request to access the metadata of the storage object, accessing the metadata of the storage object based on the first index structure and at least the part of the page table.

19. The apparatus of claim 18, wherein the page table stored in the persistent device comprises blocks and a second index structure for recording respective addresses of the blocks in the persistent storage device, wherein the reading at least the part of the page table comprises reading the second index structure from the persistent storage device, and wherein the actions further comprise reading, based on the second index structure, the blocks from the persistent storage device into the memory to restore the page table in the memory.

20. The apparatus of claim 18, wherein the first index structure is implemented as a B+ tree.
